(19) United States
(12) Patent Application Publication
(10) Pub. No.: US 2026/0184897 A1
(43) Pub. Date: Jul. 2, 2026

(54) THERMALLY CONDUCTIVE MATERIAL AND METHOD FOR PRODUCING SAME

(71) Applicants: KABUSHIKI KAISHA TOYOTA CHUO KENKYUSHO, Nagakute-shi, Aichi (JP); DENSO CORPORATION, Kariya-city, Aichi (JP)

(72) Inventors: Junghwan HWANG, Nagakute-shi (JP); Yoshie OHIRA, Nagakute-shi (JP); Masahiro HONDA, Kariya-city (JP); Motomi MUROZAKI, Kariya-city, Aichi (JP)

(73) Assignees: KABUSHIKI KAISHA TOYOTA CHUO KENKYUSHO, Nagakute-shi, Aichi (JP); DENSO CORPORATION, Kariya-city, Aichi (JP)

(21) Appl. No.: 19/126,034

(22) PCT Filed: Aug. 17, 2023
(86) PCT No.: PCT/JP2023/029739

§ 371 Date: Apr. 30, 2025

(30) Foreign Application Priority Data
Jan. 25, 2023 (JP) 2023-009113

(51) Int. Cl. C08K 7/16; B29B 7/00; B29B 7/84; B29C 35/02; B29C 43/00; B29C 43/52; B29K 63/00; B29K 505/02; B29K 507/02; C08J 3/20; C08K 3/28

(52) U.S. Cl. CPC C08K 7/16; B29B 7/005; B29B 7/84; B29C 35/02; B29C 43/003; B29C 43/52; C08J 3/203; C08K 3/28; B29K 2063/00; B29K 2505/02; B29K 2507/02; B29K 2995/0013; C08J 2363/00; C08K 2003/282; C08K 2201/001; C08K 2201/005; C08K 2201/014

(57) ABSTRACT

A thermally conductive material obtained by dispersing a filler in a matrix composed of a resin. The filler includes spherical particles composed of aluminum nitride and plate-like particles composed of boron nitride. The volume ratio of plate-like to spherical particles is, for example, 0.4 to 1.5. The particle diameter ratio of the plate-like to the spherical particles is, for example, 0.05 to 0.5. The volume percent of the filler to the thermally conductive material as a whole is, for example, 73 to 93 vol %. The thermally conductive material that satisfies such conditions can develop remarkably high thermal conductivity. The thermally conductive material can be produced through a preparation step of obtaining a mixture in which spherical particles, plate-like particles, and a resin are present in a mixed manner, and a molding step of forming the mixture into a molded body. The preparation step may be performed in multiple stages.

### TECHNICAL FIELD

The present invention relates to thermally conductive material and relevant techniques.

### BACKGROUND ART

The amount of heat generated by elements, equipment, devices, etc. increases with increasing density and performance, and sufficient heat dissipation is required to ensure their functionality, lifespan, etc. For example, in the case of electronic equipment (such as semiconductor modules), heat is dissipated through heat dissipation materials (such as heatsinks, housings, and thermally conductive sheets) that are excellent in thermal conductivity. As the heat dissipation materials, composite materials with excellent moldability are often used in addition to metals alone. Composite materials are usually composed of fillers with excellent thermal conductivity and matrices (e.g., resins including elastomers, rubber, etc.) that hold the fillers.

As fillers, for example, ceramic particles (including fibers) such as silica (SiO₂), alumina (Al₂O₃), and aluminum nitride (AlN) have been used. In recent years, boron nitride (BN) particles are also used as fillers because they are excellent in the thermal conductivity, electrical insulation, chemical stability, etc. Boron nitride has a hexagonal normal pressure phase (which may be referred to as “h-BN”) and a cubic high-pressure phase (which may be referred to as “c-BN”), and h-BN particles are usually used as a filler. The h-BN particles are plate-like particles (flat or scale-like ones) in which hexagonal mesh layers are stacked like graphite, and their thermal conductivity in the plane direction (a-axis (100) direction) is greater than that in the thickness direction (c-axis (002) direction) (thermal conductivity anisotropy).

In addition to fillers composed of a single type of particles, fillers in which two or more types of particles are present in a mixed manner are also used. Composite materials in which such fillers are held in matrices are also proposed, and for example, related descriptions are found in the following patent documents.

### PRIOR ART DOCUMENTS

### Patent Documents

Patent Document 1: JP2008-106231A
Patent Document 2: JP2011-184507A
Patent Document 3: JP2019-38912A

### SUMMARY OF INVENTION

### Technical Problem

Patent Document 1 proposes an adhesive sheet (composite material) for electronic equipment in which a powder (filler) obtained by simply mixing boron nitride powder and spherical alumina powder is present in a mixed manner in an epoxy resin (matrix) ([0056], Example 9 of Table 1). The thermal conductivity is only 3.6 W/mK at most.

Patent Document 2 proposes a sheet (composite material) in which a powder (filler) obtained by simply mixing alumina, boron nitride, and aluminum nitride is present in a mixed manner in a silicone resin (matrix) ([0027], Table 4). The thermal conductivity is only 7.2 W/mK at most.

Patent Document 3 proposes a thermally conductive foam sheet that has heat dissipation properties in addition to the flexibility required for shock absorbing materials and sealing materials. The sheet is configured such that a plate-like filler composed of boron nitride and a spherical filler composed of magnesium oxide are dispersed in a foamed ethylene propylene diene rubber. As is apparent from the examples of Patent Document 3, when the average length (B) of the plate-like filler is greater than the average particle diameter (C) of the magnesium oxide (e.g., when B/C=2), the thermal conductivity of the sheet is high both before and after foaming.

The present invention has been made in view of such circumstances, and an object of the present invention is to provide novel thermally conductive material and relevant techniques.

### Solution to Problem

As a result of intensive studies to achieve the above object, the present inventors have newly found that a thermally conductive material in which the filler dispersed in the resin (matrix) satisfies certain conditions has an improved thermal conductivity to a peak. Developing this achievement, the present inventors have accomplished the present invention, which will be described below.

### «Thermally Conductive Material»

The present invention provides a thermally conductive material obtained by dispersing a filler in a matrix composed of a resin. The filler includes spherical particles composed of aluminum nitride and plate-like particles composed of boron nitride. The volume ratio of the plate-like particles to the spherical particles is 0.4 to 1.5. The particle diameter ratio of the plate-like particles to the spherical particles is 0.05 to 0.5. The volume percent of the filler to the thermally conductive material as a whole is 73 to 93 vol %.

The thermally conductive material of the present invention can develop excellent thermal conductivity. The reason for this is not clear, but it is thought to be as follows. When the spherical particles composed of aluminum nitride and the plate-like particles composed of boron nitride satisfy certain conditions, the plate-like particles, which have excellent flexibility and lubricity (low-friction properties and sliding properties), are densely interposed between the spherical particles, and can enhance the filling property of the filler and the moldability of the thermally conductive material. This results in a dense thermally conductive material with few voids and increases the chances of contact between the spherical particles and the plate-like particles and between the plate-like particles, thus forming sufficient thermal conduction paths, which are thought to improve the thermal conductivity of the thermally conductive material. It is also thought that by arranging small plate-like particles almost uniformly around relatively large spherical particles, approximately isotropic thermal conductivity can readily be developed.

### «Method for Producing Thermally Conductive Material»

The present invention can also be perceived as a method for producing thermally conductive material. For example, the present invention may provide a method for producing the above-described thermally conductive material. The method includes: a preparation step of obtaining a mixture of spherical particles composed of aluminum nitride, plate-like particles composed of boron nitride, and a resin; and a molding step of forming the mixture into a molded body.

### «Thermally Conductive Member»

The present invention can also be perceived as a thermally conductive member. The thermally conductive member may be, for example, a material before processing (bulk material) or a product (such as a heat dissipation member, a substrate, a case, a sheet, or a film) that has been subjected to molding, processing, etc. into a desired shape. In the present specification, such thermally conductive members are also included in and referred to as “thermally conductive materials.”

### «Others»

Unless otherwise stated, a numerical range “x to y” as referred to in the present specification includes the lower limit x and the upper limit y. Any numerical value included in various numerical values or numerical ranges described in the present specification may be selected or extracted as a new lower or upper limit, and any numerical range such as “a to b” can thereby be newly provided using such a new lower or upper limit. In the present specification, unless otherwise stated, “x to y μm” means x μm to y μm. The same applies to other unit systems (such as W/mK and Ωm).

### BRIEF DESCRIPTION OF DRAWINGS

FIG. 1 is a schematic diagram illustrating an example of production steps for a thermally conductive material (specimen).

FIG. 2A is a set of SEM images when observing a cross section of Specimen 33.

FIG. 2B is a set of SEM images when observing a cross section of Specimen C31.

FIG. 2C is an SEM image when observing a cross section of Specimen C32.

FIG. 3A is a scatter diagram illustrating the relationship between the volume ratio of the filler (plate-like particles/spherical particles) and the thermal conductivity of the thermally conductive material.

FIG. 3B is a scatter diagram illustrating the relationship between the particle diameter ratio of the filler (plate-like particles/spherical particles) and the thermal conductivity of the thermally conductive material.

### EMBODIMENTS FOR CARRYING OUT THE INVENTION

One or more features freely selected from the present specification can be added to the features of the present invention. The contents described in the present specification can apply not only to thermally conductive materials, but also to methods for producing them and relevant techniques. Even methodological features can also be features regarding a product. Which embodiment is the best or not is different depending on objectives, required performance, and other factors.

### «Filler»

The filler includes at least spherical particles composed of aluminum nitride (also referred to as “AlN particles”) and plate-like particles composed of boron nitride (also referred to as “BN particles”). Boron nitride is mainly hexagonal boron nitride (h-BN).

### (1) Particle Shape

The spherical particles may be approximately spherical. Being “approximately spherical” means, for example, that the degree of circularity obtained from the observation image of the particles (e.g., SEM image) may be 0.6 or more in an embodiment or 0.7 or more in another embodiment. The theoretical upper limit of the degree of circularity is 1, but the practical upper limit is 0.98 or less.

The degree of circularity is obtained from the maximum length of the particles (L/particle diameter) and the area thereof(S) as 4S/πL². Specifically, it can be obtained by image processing of the observation image using software (such as ImageJ). Usually, the arithmetic mean value of the degree of circularity of multiple particles in the field of view (650 μm×450 μm) may be taken as the “degree of circularity.”

The plate-like particles may be flat. Being “flat” means, for example, that the aspect ratio (L/t), which is the ratio of the maximum length of the particles (L/particle diameter) to the minimum length of the particles (t/thickness), is, for example, 3 to 300 in an embodiment (or 20 to 200 in another embodiment). The minimum length (t) and maximum length (L) of particles are obtained from the above-described observation image. Usually, the arithmetic mean value of the aspect ratios obtained for multiple particles in the above-described field of view may be taken as the “aspect ratio (AR).”

### (2) Particle Diameter (Size)

Regardless of the particle shape, the size of particles is referred to as the “particle diameter.” The “particle diameter” is indicated, for example, by the maximum length (L) of particles. The average value of the maximum lengths (L) obtained for multiple particles may also be taken as the “particle diameter.” In this case, for example, the arithmetic mean value of the particle diameters of the particles within the field of view (650 μm×450 μm) of the above-described observation image may be taken as the “particle diameter.” Thus, the “particle diameter” is obtained for particles contained in the thermally conductive material (composite material) or particles that are separated/extracted from the thermally conductive material.

If the particles are in the stage of raw material powder, the 50% diameter (D50: median diameter) determined from the particle size distribution obtained by the laser diffraction method may be taken as the “particle diameter” as referred to in the present specification. Furthermore, the nominal value (catalog value) for the raw material powder may be adopted as the “particle diameter” as referred to in the present specification.

### (3) Particle Diameter Ratio

The ratio of the particle diameter (L2) of the plate-like particles to the particle diameter (L1) of the spherical particles (particle diameter ratio: L2/L1) is, for example, 0.05 to 0.5, 0.08 to 0.35, 0.15 to 0.3, or 0.18 to 0.25. If the particle diameter ratio is unduly small or large, the thermal conductivity of the thermally conductive material may decrease.

Provided that the particle diameter ratio is within a predetermined range, the specific “particle diameter” itself is not limited. It will be sufficient to say that the particle diameter of the spherical particles is, for example, 10 to 200 μm, 20 to 150 μm, 35 to 120 μm, or 40 to 95 μm. The particle diameter of the plate-like particles is, for example, 2 to 100 μm, 4 to 75 μm, 8 to 50 μm, or 15 to 35 μm.

### (4) Volume Ratio

The ratio of the total volume (V2) of the plate-like particles to the total volume (V1) of the spherical particles (volume ratio: V2/V1) is, for example, 0.4 to 1.5, 0.5 to 1.4, or 0.6 to 1.2. If the volume ratio is unduly small or large, the thermal conductivity of the thermally conductive material may decrease. If the volume ratio is unduly large, the raw material cost may also increase due to the increase in the plate-like particles.

The volume of particles is calculated from their mass (content) and true density. For example, if the particles are contained in the thermally conductive material, the volume is calculated from the mass and true density of the separated/extracted particles. If the particles are in the stage of raw material powder, the volume of the particles is calculated from the compounding mass and true density.

### (5) Other Particles

The filler may contain one or more types of particles other than the above-described particles (AlN particles and BN particles). Examples of other particles include aluminum oxide (such as Al₂O₃), silicon oxide (such as SiO₂), and cubic boron nitride (c-BN). All particles of the thermally conductive material used for electronic equipment, or the like may be composed of non-conductive substances (insulating materials).

### (6) Surface Treatment

The entire or part of the filler may be subjected to surface treatment to increase the affinity with the matrix. The surface treatment improves the dispersibility, filling property, adhesion, etc. of the filler in the matrix, thus improving the thermal conductivity of the thermally conductive material.

The surface treatment is, for example, a hydrophobic treatment or a coupling treatment. Specific examples include a silane coupling treatment and fluorine plasma treatment. The surface treatment may be performed directly on the filler before mixing (including kneading) or may also be performed by adding a surface treatment agent (such as a coupling agent) when mixing (kneading) the matrix and the filler.

### «Matrix»

The filler is dispersed and held in a matrix composed of a resin almost uniformly. The resin (including rubber, elastomer, etc.) may be a thermosetting resin or a thermoplastic resin. The thermosetting resin may be appropriately subjected to a thermally curing treatment (curing treatment).

Thermosetting resin is, for example, an epoxy resin, a phenolic resin, a silicone resin, or the like. Thermoplastic resin is, for example, polystyrene, polymethyl methacrylate, polycarbonate, polyphenylene sulfide, or the like. The rubber is, for example, ethylene-propylene-diene rubber (EPDM), butyl rubber, or the like.

### «Filling Rate»

The filler is contained in an amount, for example, of 73 to 93 vol %, 75 to 90 vol %, or 77 to 87 vol % with respect to the entire thermal conductive material. If the filler is unduly little, the thermal conductivity may decrease. If the filler is unduly much, molding itself will be difficult. The remaining part other than the filler is usually a resin (matrix).

The filling rate (vol %) of the filler is specified from the compound amount and density of the raw materials when producing the thermally conductive material. The filling rate of the filler in the thermally conductive material is specified from the total amount of the thermally conductive material and the amount of filler extracted/separated from the thermally conductive material. If the filler cannot be extracted/separated, the filling rate may be specified indirectly or alternatively from an observation image (such as an SEM image) of the thermally conductive material (cross section).

### «Production Method»

The thermally conductive material is obtained, for example, through a preparation step of obtaining a mixture in which at least spherical particles, plate-like particles, and a resin are present in a mixed manner, and a molding step of forming the mixture into a molded body.

### (1) Preparation Step

The particles (powder) and resin may be mixed in a single step or multiple steps. The multiple steps are composed, for example, of a first mixing step of obtaining a first mixture in which a part of the particles and/or resin is mixed, and a second mixing step of obtaining a second mixture in which the remaining part of the particles and/or resin is mixed with the first mixture. In this case, the particles may be divided and mixed, the resin may be divided and mixed, or both may be divided and mixed. The division may be performed by dividing the mixed amount or by type. For example, one of the spherical particles and the plate-like particles may be mixed with a part of the resin in the first mixing step, and the other of the spherical particles and the plate-like particles may be mixed with the remaining part of the resin in the second mixing step.

When the amount of resin is divided, the preparation step may be performed, for example, by a first mixing step of obtaining a first mixture in which 5 to 25 mass % in an embodiment or 10 to 20 mass % in another embodiment of the entire resin is mixed with the particles (spherical particles and plate-like particles), and a second mixing step of obtaining a second mixture in which the remaining part of the entire resin is mixed with the first mixture. By performing the preparation step in such multiple stages, a dense thermally conductive material with a low void ratio can readily be obtained, and the thermal conductivity of the thermally conductive material is improved.

Mixing is performed, for example, using a ball mill, a vibration mill, a V-type mixer, etc. The preparation step (mixing step) may be performed by adding a solvent or the like that adjusts the viscosity of the resin. The solvent or the like may be removed by volatilization/evaporation (drying step). The mixture may be appropriately subjected to disintegration, pulverization, etc. and provided to the molding step as a compound. The compound may be adjusted to have an average particle diameter (median diameter: D50) of 5 to 60 μm in an embodiment or 15 to 55 μm in another embodiment.

### (2) Molding Step

The molded body is obtained, for example, by subjecting the mixture (compound) to pressurization molding. The molding pressure is, for example, 10 to 100 MPa in an embodiment or 20 to 50 MPa in another embodiment. The molding step may be performed by compression molding, injection molding, transfer molding, or the like.

The molding step may be cold molding performed in an ordinary temperature (room temperature) range or warm molding performed by heating the mixture. Warm molding may be performed, for example, at a temperature at which the resin softens or melts. The temperature (T) of the warm molding is, for example, −30° C. to 30° C. relative to the softening point (Ts) or melting point (Tm) of the resin (|T−(Ts, Tm)|≤30° C.) in an embodiment or −20° C. to 20° C. (|T−(Ts, Tm)|≤20° C.) in another embodiment.

The molded body (thermally conductive material) may be in the shape of a final product or a shape close to the final product, or may also be a material, an intermediate material, or the like to be processed.

### «Application»

The thermally conductive material is used, for example, as a thermally conductive member for heat dissipation sheets, substrates, cases, etc. The thermal conductivity of the thermally conductive material can be, for example, 10 to 40 W/mK, 15 to 30 W/mK, or 20 to 25 W/mK. The thermally conductive material may have anisotropic or isotropic thermal conductivity. When the difference in thermal conductivity between two orthogonal directions is, for example, 6 W/mK or less, 4 W/mK or less, or even 2 W/mK or less, the applications of the thermally conductive material can be expanded. The specific resistance of the thermally conductive material used for electronic equipment, etc., may be, for example, 10⁵ to 10¹² Ωm or 10⁸ to 10¹⁰ Ωm.

### EXAMPLES

Various composite materials (thermally conductive materials) in which fillers were dispersed and held in matrices were produced, and their thermal conductivity characteristics were evaluated. The present invention will be described in more detail while illustrating such specific examples.

### «Fillers»

One or more types of spherical particles and plate-like particles listed below were used as fillers.

### (1) Spherical Particles

Two or more aluminum nitride powders listed below were prepared as sources of spherical particles. Each powder is composed of approximately spherical AlN particles (e.g., degree of circularity: 0.90).
Powder a1: FAN-f50 available from Furukawa Denshi Co., Ltd./D50: 50 μm
Powder a2: FAN-f80 available from Furukawa Denshi Co., Ltd./D50: 90 μm

### (2) Plate-Like Particles

Several boron nitride powders listed below were prepared as sources of plate-like particles. Each powder is composed of plate-like BN particles (flat/e.g., AR: 4 to 18).
Powder b1: HGP available from Denka Company Limited/D50: 5 μm
Powder b2: GP available from Denka Company Limited/D50: 13 μm
Powder b3: SGP available from Denka Company Limited/D50: 20 μm
Powder b4: PT110 available from Momentive Performance Materials/D50: 40 μm

### «Matrix»

The matrix used to hold the filler was an epoxy resin (EP-160 available from CEMEDINE CO., LTD./one-part heat-curing epoxy-based adhesive). This epoxy resin was a highly viscous liquid in an ordinary temperature range.

### «Composite Materials»

(1) Using the powders to be the particle sources and the resin, a number of specimens (composite materials) were produced as listed in Table1. Specimens C1 and C31 used only spherical particles as the fillers. Specimen C32 used only plate-like particles (powder b3) as the filler. The plate-like particles used in Specimens 41 to 49 were subjected to particle size adjustment before the use.

For each specimen using a filler obtained by mixing spherical particles and plate-like particles, the particle diameter ratio and volume ratio of the plate-like particles to the spherical particles are also listed in Table1. The volumes of the spherical particles and plate-like particles were obtained from the true density of each particle and the compounding amount (mass ratio) of the powder as the particle source.

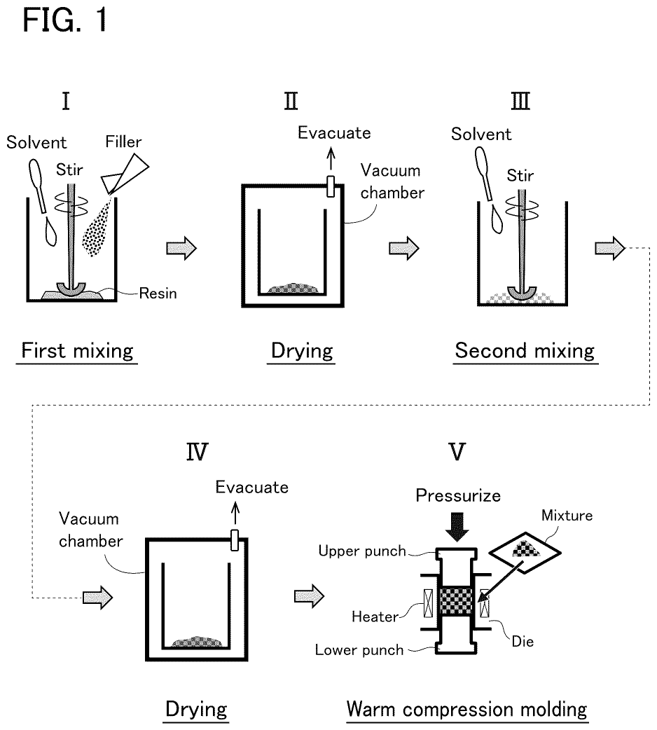

(2) The composite material for each specimen was produced according to the procedure illustrated in FIG. 1. Specifically, the procedure is as follows.

In a polypropylene container, 1 to 10 cc of solvent (dichloromethane) and 4.4 g of filler were added to 0.04 g of epoxy resin (10% of the total resin amount), and they were kneaded (mixed) (Step I/First mixing step). The kneading was performed under room temperature using a mixer (ARE-310 “RENTARO” available from THINKY CORPORATION) at 2000 rpm×0.5 min.

The kneaded product obtained was placed in a vacuum chamber and vacuum-dried (for 30 min) under room temperature (Step II/First drying step). Thus, a kneaded product (first mixture) from which the solvent had been volatilized was obtained.

To the kneaded product, 0.35 g of epoxy resin (remaining part of the total resin amount) and 1 to 10 cc of solvent (dichloromethane) were added, and they were kneaded (mixed) (Step III/Second mixing step). The kneading was performed under room temperature using the above-described device without any change at 2000 rpm×0.5 min.

The kneaded product obtained was placed in a vacuum chamber and vacuum-dried (for 30 min) under room temperature (Step IV/Second drying step). Thus, a kneaded product (second mixture) from which the solvent had been volatilized was obtained.

The cavity of a mold (die) heated by a heater was filled with the kneaded product (second mixture), which was subjected to warm compression molding in one axis direction (Step V/Molding step). At this time, the mold temperature was 130° C. and the molding pressure was 20 MPa. The pressurized state was maintained for 30 minutes to thermally cure the resin. Through this operation, a cylindrical composite body (φ14 mm×20 mm) in which the filler was held by the resin was obtained. The temperature at which the epoxy resin before the molding step was softened or melted was 80° C.

### «Observation»

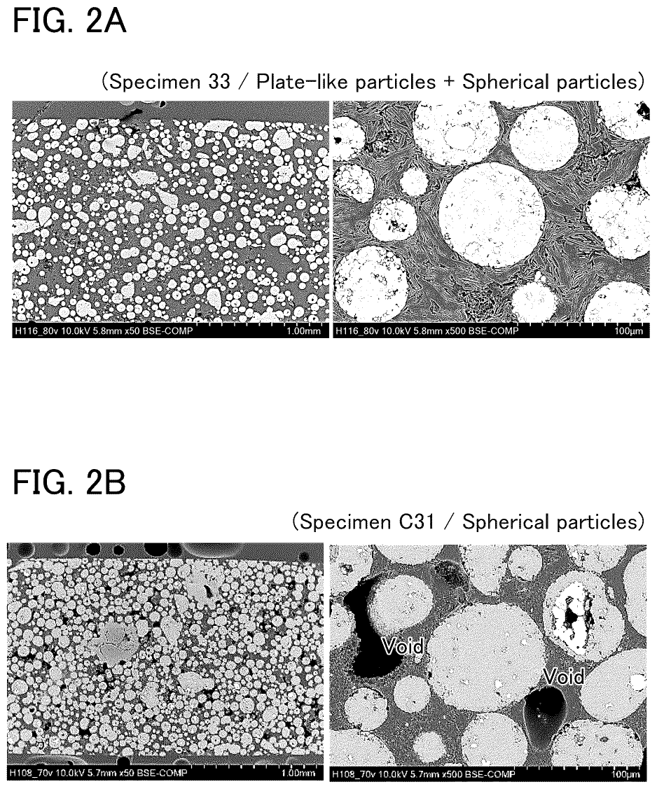

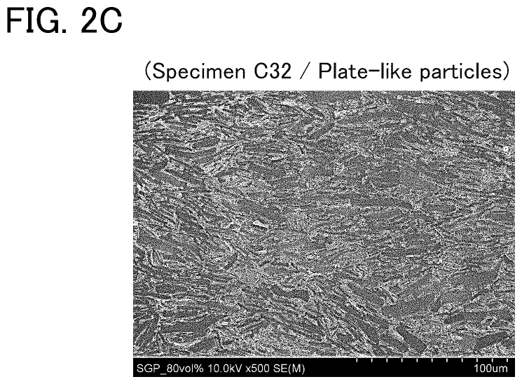

Cross sections (planes parallel to the pressurizing direction during the molding of the composite materials) of Specimen 33, Specimen C31, and Specimen C32 were observed with a scanning electron microscope (SEM). The observed images are shown in FIGS. 2A to 2C (collectively referred to as “FIG. 2”). FIGS. 2A and 2B each show an overall image and an enlarged image.

### «Measurement»

### (1) Void Ratio

The void ratio of the composite material of each specimen is also listed in Table1. The void ratio was calculated from the (true) density (ρ) and theoretical density (ρth) of the composite material as {(ρth−ρ)/ρth}×100(%). The (true) density (ρ) was calculated from the actually measured mass and volume of the composite material (Archimedes method). The theoretical density (ρth) was calculated based on the compounding ratio and density of the raw materials (particles and resin) used to produce the composite material.

### (2) Thermal Conductivity

The thermal conductivity of the composite material of each specimen is also listed in Table1. The thermal conductivity (λ) was obtained using the nano-flash method (measurement device: LFA447 available from NETZSCH). Specifically, the thermal conductivity was calculated as λ=α·Cp·ρ from the thermal diffusivity (α) measured by the nano-flash method, the specific heat (Cp) obtained using a differential scanning calorimeter (DSC), and the density (ρ) obtained by the Archimedes method.

In this measurement, a thin plate-like sample perpendicular to the axial direction (pressurizing direction) (referred to as a “perpendicular sample”) and a thin plate-like sample parallel to the axial direction (referred to as a “parallel sample”) were cut out from the composite material of each specimen, and the thermal conductivity was obtained for each sample. However, there was not much difference between the thermal conductivities of the two, so only the thermal conductivity obtained from the perpendicular sample is listed in Table1.

### «Evaluation»

### (1) Volume Ratio

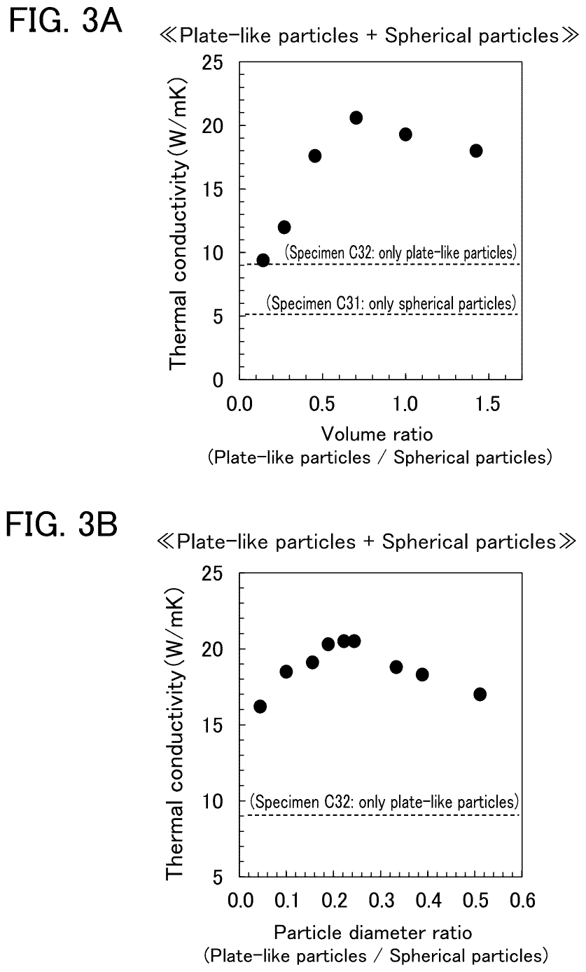

The relationship between the volume ratio and the thermal conductivity is illustrated in FIG. 3A based on Specimens 31 to 36, Specimen C31, and Specimen C32 listed in Table1. As apparent from FIG. 3A, it has become clear that when the filler is composed of spherical particles and plate-like particles and the volume ratio between them is 0.4 to 1.5, the thermal conductivity becomes significantly larger.

Also, as found from the comparison between Specimen 33 and Specimen 37, the tendency was the same regardless of the particle diameter ratio or the particle diameter of the plate-like particles.

### (2) Particle Diameter Ratio

The relationship between the particle diameter ratio and the thermal conductivity is illustrated in FIG. 3B based on Specimens 41 to 49 listed in Table1. As apparent from FIG. 3B, it has become clear that when the filler is composed of spherical particles and plate-like particles and the particle diameter ratio between them is 0.05 to 0.5, the thermal conductivity becomes significantly larger.

### (3) Filling Rate

Specimens 11 to C1, Specimens 21 to C2, Specimens 31 to C32, and Specimens 41 to 49 listed in Table1 have different filling rates of the fillers. Comparing these, it has also been found that the above-described tendency (relationship between the thermal conductivity and the volume ratio or particle diameter ratio) can occur when the filling rate of the filler is more than 70 vol % (73 vol % or more).

### (4) Structure/Organization

From the observation images of Specimen 33 shown in FIG. 2A, it has been found that the thermally conductive material that exhibits high thermal conductivity has no voids and the plate-like particles bridge between the spherical particles to form many thermal conductive paths.

On the other hand, from the observation images of Specimen C31 shown in FIG. 2B, it has been found that the thermally conductive material, in which the filler is composed only of the spherical particles, causes many voids and has low thermal conductivity.

Furthermore, from the observation image of Specimen C32 shown in FIG. 2C, it has also been found that the thermally conductive material, in which the filler is composed only of the plate-like particles, has a small void ratio, but does not improve the thermal conductivity.

From the above, it has become clear that the thermally conductive material of the present invention can develop remarkably excellent thermal conductivity.

TABLE 1

| | Configuration | | | | | | |
|---|---|---|---|---|---|---|---|
| | Filler | | | | | | |
| | | | Particle | | | | |
| | | | diameter ratio | Volume ratio | | | |
| | Average particle diameter | | (Plate-like | (Plate-like | | Characteristics | |
| | (D50/μm) | | particles/ | particles/ | Filling | Void | Thermal |
| Specimen | Spherical | Plate-like | Spherical | Spherical | rate | ratio | conductivity |
| No. | particles | particles | particles) | particles) | (vol %) | (%) | (W/mK) |
| 11 | 50 | 20 | 0.40 | 0.75 | 50 | 0 | 6 |
| 12 | | 40 | 0.80 | | | 0 | 7 |
| C1 | | — | — | — | | 0 | 6 |
| 21 | 50 | 5 | 0.10 | 0.75 | 70 | 0 | 11 |
| 22 | | 13 | 0.26 | | | 0 | 11 |
| 23 | | 20 | 0.40 | | | 0 | 15 |
| 24 | | 40 | 0.80 | | | 0 | 15 |
| C2 | | — | — | — | | 15 | 5 |
| 31 | 90 | 20 | 0.22 | 1.42 | 80 | 3 | 18 |
| 32 | | | | 1.00 | | 0 | 19 |
| 33 | | | | 0.70 | | 0 | 21 |
| 34 | | | | 0.45 | | 3 | 18 |
| 35 | | | | 0.27 | | 9 | 12 |
| 36 | | | | 0.14 | | 11 | 9 |
| 37 | | 40 | 0.44 | 0.70 | | 1 | 20 |
| C31 | | — | — | — | | 22 | 5 |
| C32 | — | 20 | — | — | | 3 | 9 |
| 41 | 90 | 4 | 0.04 | 0.70 | 80 | 0 | 16 |
| 42 | | 9 | 0.10 | | | 0 | 19 |
| 43 | | 14 | 0.16 | | | 0 | 19 |
| 44 | | 17 | 0.19 | | | 0 | 20 |
| 45 | | 20 | 0.22 | | | 0 | 21 |
| 46 | | 22 | 0.24 | | | 0 | 21 |
| 47 | | 30 | 0.33 | | | 0 | 19 |
| 48 | | 35 | 0.39 | | | 0 | 18 |
| 49 | | 46 | 0.51 | | | 2 | 17 |

◯: Containing/—: Not containing

1. A thermally conductive material obtained by dispersing a filler in a matrix composed of a resin, the filler comprising spherical particles composed of aluminum nitride and plate-like particles composed of boron nitride,
the plate-like particles having a volume ratio to the spherical particles of 0.4 to 1.5,
the plate-like particles having a particle diameter ratio to the spherical particles of 0.05 to 0.5,
the filler having a volume percent to the thermally conductive material as a whole of 73 to 93 vol %.

2. The thermally conductive material according to claim 1, wherein the volume ratio is 0.6 to 1.2.

3. The thermally conductive material according to claim 1, wherein the particle diameter ratio is 0.08 to 0.35.

4. The thermally conductive material according to claim 1, wherein the resin is a thermosetting resin.

5. A method for producing a thermally conductive material, comprising:
a preparation step of obtaining a mixture of spherical particles composed of aluminum nitride, plate-like particles composed of boron nitride, and a resin; and
a molding step of forming the mixture into a molded body,
wherein the thermally conductive material according to claim 1 is obtained.

6. The method for producing a thermally conductive material according to claim 5, wherein the preparation step comprises:
a first mixing step of obtaining a first mixture composed of 5 to 25 mass % of the resin as a whole, the spherical particles, and the plate-like particles; and
a second mixing step of obtaining a second mixture composed of the first mixture and a remaining part of the resin as the whole.

7. The method for producing a thermally conductive material according to claim 5, wherein
the resin is a thermosetting resin, and
the method further comprises a thermally curing step of heating the molded body to cure the resin.
